(19) United States
(12) Patent Application Publication
(10) Pub. No.: US 2017/0247997 A1
(43) Pub. Date: Aug. 31, 2017

(54) A METHOD OF TREATING A SUBTERRANEAN FORMATION

(71) Applicant: SCHLUMBERGER TECHNOLOGY CORPORATION, Sugar Land, TX (US)

(72) Inventor: Oleg Valerievich KOVALEVSKY, Kotsovo (RU)

(21) Appl. No.: 15/505,533

(22) PCT Filed: Aug. 20, 2014
(86) PCT No.: PCT/RU2014/000621

§ 371 Date: Feb. 21, 2017

(51) Int. Cl. E21B 43/267; C09K 8/80; C09K 8/94; C09K 8/68; C09K 8/88; C09K 8/70; E21B 43/26; C09K 8/64

(52) U.S. Cl. CPC E21B 43/267; E21B 43/26; C09K 8/80; C09K 8/64; C09K 8/685; C09K 8/887; C09K 8/703; C09K 8/94; C09K 2208/08

(57) ABSTRACT

A method of treating a subterranean formation from a well, the method which comprises preparing a proppant slurry which comprises (a) proppant particles and (b) a first carrier fluid; preparing a proppant free injection liquid which comprises a second carrier fluid wherein the first and second carrier fluids are immiscible and wherein no proppant is intentionally added to the proppant free injection liquid; and injecting the proppant slurry and the proppant free injection liquid into the formation, is provided.

### BACKGROUND

Hydraulic fracturing is a widely used oil and gas production stimulation technique. A fracture is created in a subterranean formation by injecting fluid at a pressure higher than the fracturing pressure of the formation. Along with the fluid, proppant is also placed in the fracture to prevent the closure of the fracture when the pressure is released at the end of stimulation treatment. After the treatment, hydrocarbons flow from the formation to the wellbore between the fracture walls which are prevented from closing by proppant. In conventional usage, the proppant forms homogeneous proppant packs. However, alternative ways of placing proppant in order to improve fracture conductivity have been studied.

One approach to improvement of fracture conductivity is related to heterogeneous proppant placement (HPP). This is achieved by placing of pillars, made of aggregated proppant particulates called proppant slugs, capable of keeping the fracture opened along its length, and providing channels between each other. One way in which such proppant slugs are introduced into the formation is using pulsed introduction of proppant laden fracturing fluids into the subterranean formation. Once placed in the subterranean formation, proppant slugs may disperse thereby degrading their propping efficiency and conductivity.

### SUMMARY

In at least one aspect, the disclosure provides a method of treating a subterranean formation from a well, the method comprising preparing a proppant slurry which comprises (a) proppant particles and (b) a first carrier fluid; preparing a non-proppant injection liquid which comprises a second carrier fluid wherein the first and second carrier fluids are immiscible and wherein no proppant is added to the non-proppant injection liquid; and injecting the proppant slurry and the non-proppant injection liquid into the formation.

### BRIEF DESCRIPTION OF THE DRAWINGS

FIG. 1 is a schematic illustrating equipment for implementing a first embodiment of the disclosed method; and

FIG. 2 is a schematic illustrating equipment for implementing a second embodiment of the disclosed method.

### DETAILED DESCRIPTION OF SOME ILLUSTRATIVE EMBODIMENTS

For the purposes of promoting an understanding of the principles of the disclosure, reference will now be made to some illustrative embodiments of the current application.

Although the following discussion emphasizes fracturing, the disclosed subject matter may be used in other downhole operations including, for example, combined fracturing and gravel packing in a single operation. Some embodiments of the disclosed subject matter may be described in terms of treatment of vertical wells, but are equally applicable to wells of any orientation. Embodiments may be described for hydrocarbon production wells, but it is to be understood that embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. It should also be understood that fracture closure includes partial fracture closure.

As used herein, the term hydraulic fracturing treatment means the process of pumping fluid into a closed wellbore to create enough downhole pressure to crack or fracture the formation. This allows injection of proppant-laden fluid into the formation, thereby creating a region of high-permeability through which fluids can flow. The proppant remains in place once the hydraulic pressure is removed and therefore props open the fracture and enhances flow into or from the wellbore.

In a first embodiment, the disclosed subject matter is a method of treating a subterranean formation from a well comprising preparing a proppant slurry which comprises (a) proppant particles and (b) a first carrier fluid; preparing a proppant free injection liquid which comprises a second carrier fluid wherein the first and second carrier fluids are immiscible and wherein no proppant is added to the proppant free injection liquid; and injecting the proppant slurry and the proppant free injection liquid into the formation.

As used herein, the term immiscible means the property wherein two substances are not capable of combining to form a homogeneous mixture. Immiscibility does not preclude the insubstantial solubility under temperatures and pressures elevated above ambient temperature and atmospheric pressure.

Any acceptable fluid may be used as the first and second carrier fluids provided the first carrier fluid and the second carrier fluid are immiscible in each other. Carrier fluids include oil-based fluids and aqueous-based fluids. Carrier fluids include hydratable gels (e.g. gels containing polysaccharides such as guars, xanthan and diutan, hydroxyethylcellulose, polyvinyl alcohol, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and oil-based fluids including a gelled, foamed, or otherwise viscosified oil.

Suitable oil-based fluids for use in the first or second carrier fluids include, for example, liquefied natural gas, oil-based crosslinked gels, diesel, kerosene, jet fuel, crude oil, condensate, an ester, linear-α-olefin, poly-α-olefin, internal olefin, paraffin, linear alkyl benzene, ester, acetal, or other synthetic. In one embodiment of the disclosure, the first carrier fluid is an oil-based fluid. In a particular embodiment, the first oil-based carrier fluid is based on liquefied natural gas. In yet another embodiment, the first oil-based carrier fluid is an oil-based crosslinked gel. In a specific embodiment of the disclosure, the first carrier fluid is an oil-based fluid and the second carrier fluid is an aqueous-based fluid. In a yet more specific embodiment, the second carrier fluid is a water-based crosslinked gel.

Suitable aqueous-based carrier fluids may include, for example, fresh water, salt water, brine (saturated salt water), seawater, produced water (i.e., subterranean formation water brought to the surface), surface water (e.g., lake or river water), and flow back water (i.e., water placed into a subterranean formation and then brought back to the surface). In another embodiment of the disclosure, the first carrier fluid is an aqueous-based fluid. In yet another embodiment, the second carrier fluid is an oil-based fluid. In a specific embodiment of the disclosure, the first carrier fluid is an aqueous-based fluid and the second carrier fluid is an oil-based fluid.

The disclosure further provides the method according to any embodiment described herein, except that the first and/or second carrier fluid may be gelled to better support the transport of the proppant, fibers and/or other particulates into the subterranean formation.

The disclosure further provides the method according to any embodiment described herein, except that the aqueous-based fluid comprises no polar components and no oleophilic components.

Any suitable material may be used as the proppant in the proppant slurry. In those embodiments in which the first carrier fluid is oil-based, the proppant material(s) should be readily dispersible in the oil-based carrier fluid. In those embodiments in which the first carrier fluid is aqueous-based, the proppant material(s) should be readily dispersible in the aqueous-based carrier fluid. Exemplary proppant materials include sand, walnut shells, sintered bauxite, glass beads, ceramic materials, naturally occurring materials, or similar materials. Mixtures of one or more proppant materials can be used in embodiments of the disclosed subject matter. The proppant materials may have any shape including for example, spheres, plates, fibers, irregularly shaped particles, irregular beads, flakes, ribbons, platelets, rods, tubes or any combination of two or more thereof. In a particular embodiment, the proppant has a plate structure.

Depending upon the type of subterranean formation being treated and the intended type of treatment operation being conducted, other components may be optionally included in one or both of the proppant slurry and non-proppant injection liquid. Such components may include, for example, salts, pH control additives, surfactants, foaming agents, antifoaming agents, breakers, biocides, crosslinkers, additional fluid loss control agents, stabilizers, chelating agents, scale inhibitors, gases, mutual solvents, particulates, corrosion inhibitors, oxidizing agents, reducing agents, antioxidants, relative permeability modifiers, viscosifying agents, gravel particulates, scale inhibitors, emulsifying agents, de-emulsifying agents, iron control agents, clay control agents, flocculants, scavengers, lubricants, friction reducers, viscosifiers, weighting agents, hydrate inhibitors, consolidating agents, delay agents, any combination thereof, and the like. A person having ordinary skill in the art, with the benefit of this disclosure, will recognize when such optional additives should be included, as well as the appropriate amounts to include.

The disclosure further provides the method of treating a subterranean formation from a well according to any embodiment disclosed herein except that the first and/or second carrier fluids further comprise fibers. Any suitable polymeric fibers may be used, including for example, fibers comprising polyester, polylactic acid (PLA), polyglycolic acid (PGA), polyethyleneterephthalate (PET), polyamides copolymers, and any mixture thereof. Fibers made of cellulose, wool, basalt, glass, rubber, and any mixture thereof may be used. Mixtures of polymeric and other fibers may also be used.

The disclosure further provides the method of treating a subterranean formation from a well according to any embodiment disclosed herein except that the first carrier fluid and/or the second carrier fluid are in the form of a foam. Use of foams in well injection liquids are known and include, for example, energized fluids (e.g. an N₂ or CO₂ based foam).

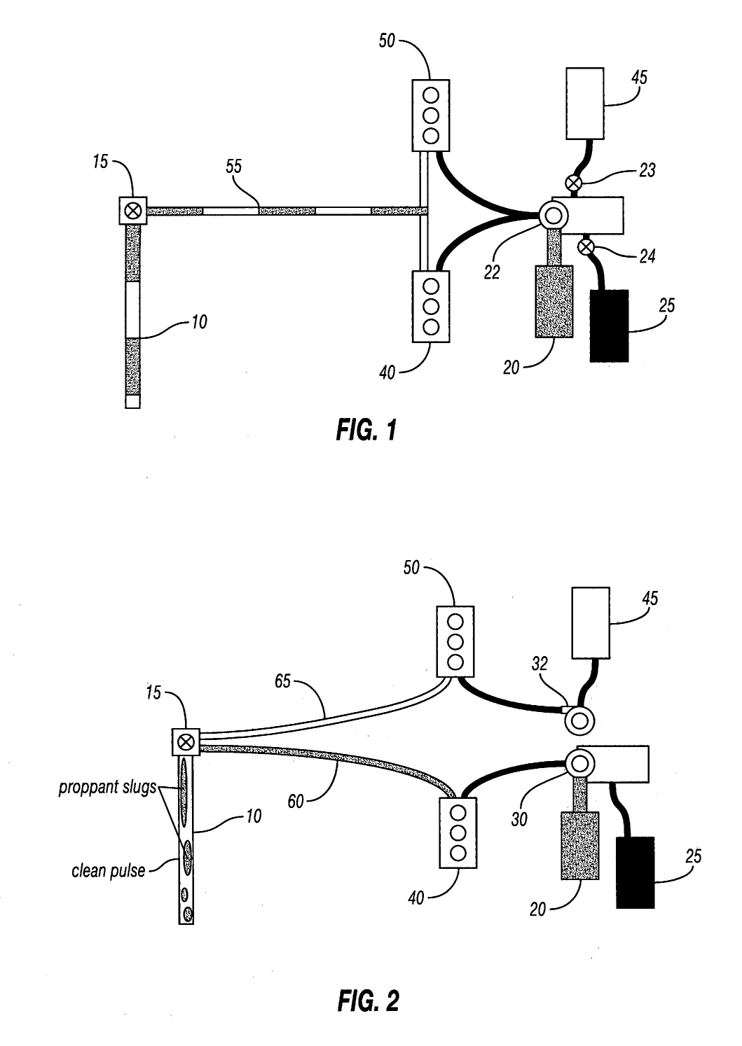

The disclosure further provides the method of treating a subterranean formation from a well according to any embodiment disclosed herein, except that the injecting the proppant slurry and the non-proppant injection fluid comprises alternating injection of the proppant slurry and injection of the non-proppant injection fluid through a single injection line into the wellhead. One manner of implementing such embodiment is illustrated in FIG. 1. Referring to FIG. 1. Referring to FIG. 1, a single injection line to the wellhead system is schematically shown. A wellbore 10 extends from a wellhead 15 into a subterranean formation (not shown). In the embodiment shown in FIG. 1, the first carrier fluid is an oil-based fluid and the second carrier fluid is an aqueous-based fluid. The proppant supply is held within proppant supply container 20 and the first carrier liquid is held within first carrier liquid container 25. The second carrier fluid is held in supply container 45. The treatment includes injecting alternating portions proppant slurry, which is a mixture of the proppant and first carrier fluid, and portions of proppant free second carrier fluid. In other words, at each moment during the treatment either the first carrier fluid and proppant are mixed in the blender 22 and supplied to both high pressure pumps 40 and 50 while second carrier fluid supply is blocked, or the supply of the proppant and first carrier fluid is blocked and second carrier fluid is transferred by blender 22 to both high pressure pumps 40 and 50. Valve 23 is closed and valve 24 is open when the combined first carrier fluid and proppant are pumped to high pressure pumps 40 and 50. Likewise, valve 23 is open and valve 24 closed when the second carrier fluid is sent to high pressure pumps 40 and 50. While not shown in FIG. 1, one skilled in the art will readily understand that valves, meters, and additional pumps may be used to operate the system shown in FIG. 1.

The disclosure further provides a system for operating the disclosed method of treating a subterranean formation from a well wherein the injecting the proppant slurry and the proppant free injection fluid into the wellhead occurs through separate wellhead supply lines. One manner of implementing such embodiment is shown in FIG. 2. Referring to FIG. 2, the wellbore 10 extends from the wellhead 15 into a subterranean formation (not shown). In the embodiment shown in FIG. 2, the first carrier fluid is an oil-based fluid and the second carrier fluid is an aqueous-based fluid. The proppant supply is held within proppant supply container 20 and the first carrier liquid is held within first carrier liquid container 25. The first carrier fluid and the proppant are supplied to the blender 30 wherein the proppant slurry is formed. The proppant slurry is sent to a first high pressure pump 40. The second carrier fluid is held in supply container 45 and supplied to a second high pressure pump 50 by use of a low pressure pump 32. The proppant slurry is fed to wellhead 15 through a first wellhead supply line 60. The proppant free injection liquid (which in FIG. 2 is the second carrier fluid) is fed to wellhead 15 through second wellhead supply line 65. The feeds to the wellhead from the first high pressure pump and the second high pressure pump may be pulsed or simultaneous. Areas of proppant slurry are shown as dotted areas in the wellbore 10 and first wellhead supply line 60 and areas of nonproppant injection fluid are shown as clear areas in the wellbore 10 and the second wellhead supply line 65.

The disclosure further provides the method of treating a subterranean formation from a well according to any embodiment disclosed herein further comprising forming heterogeneous proppant clusters in the subterranean formation.

### EXAMPLES

The following examples are intended to illustrate but not limit the disclosure herein.

### Preparation of the Oil-Based Carrier Fluid

A portion of oil-based gel YF “GO” IV, which is commercially available from Schlumberger Limited, was prepared based on 250 ml of mineral oil as per procedure described in Schlumberger Fracturing Materials Manual (PPC WS SFE\PPC WS SFE\FMM Vol II, 5769288\1.0aelease Date: 28-Jun.-2012\EDMS UID: 1656236078\Produced: 28-Jun.-2012 17:02:21).

250 ml of mineral oil are added to a 1 liter bottom-impeller waring blender at room temperature (about 27 ° C.). Mixing is started at 2000 rpm. 0.5 ml (equivalent to 2 gpt) of activator was added to the mineral oil in the mixer. 1.5 ml (equivalent to 6 gpt) of cross-linker was added to the mixer. The activator comprises from 30 to 60 percent by weight aluminum aliphatic hydrocarbon, from 10 to 30 percent by weight aliphatic alcohol, and from 10 to 30 percent by weight diesel oil (CAS No. 68334-30-5). The cross-linker comprises from 60 to 90 percent by weight alkyl phosphate ester and from 10 to 10 to 30 percent by weight aromatic hydrocarbon solvent (CAS No. 64741-67-9). After 2 minutes, it was visually observed that the viscosity had increased and a gel formed.

### Addition of Proppant (Sand) to the Oil Based Fluid

240 g (equivalent to 8 ppa) of 40/70 sand was added to oil based gel in the mixer and allowed to disperse within the gel.

### Stability Testing in an Aqueous-Based Carrier Fluid

500 ml of water was added to a beaker. A few small portions (˜20 g) of oil-based slurry were added to the water. Upon visual observation, no sand particles dispersed in water. Further, upon manual shaking; the oil-based gel with sand did not disperse or break up.

### Stability Testing at Increased Temperatures

70 ml of water was added to a 150 ml glass bottle. 70 ml of the oil-based gel with sand dispersed therein was added to the same bottle. The bottle was shaken manually. The content of the glass bottle was heated to 90° C. and the glass bottle manually shaken. Upon visual observation, no the oil-based gel with sand did not disperse or break up and no sand particles were dispersed in water.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

We claim:

1. A method of treating a subterranean formation from a well, the method comprising:
preparing a proppant slurry which comprises (a) proppant particles and (b) a first carrier fluid;
preparing a proppant free injection fluid which comprises a second carrier fluid wherein the first and second carrier fluids are immiscible and wherein no proppant is intentionally added to the proppant free injection liquid; and
injecting the combination of the proppant slurry and the proppant free injection liquid into the formation.

2. The method of treating a subterranean formation from a well according to claim 1, wherein the first carrier fluid is an oil-based fluid and the second carrier fluid is a water-based fluid.

3. The method of treating a subterranean formation from a well according to claim 1, wherein the first carrier fluid is a water-based fluid and the second carrier fluid is an oil-based fluid.

4. The method of treating a subterranean formation from a well according to claim 1, where first carrier fluid is oil-based and second carrier fluid is paraffin-based.

5. The method of treating a subterranean formation from a well according to claim 1, where first carrier fluid is paraffin-based and second carrier fluid is oil-based.

6. The method of treating a subterranean formation from a well according to claim 2, wherein the first carrier fluid is based on liquefied natural gas.

7. The method of treating a subterranean formation from a well according to claim 2, wherein the first carrier fluid is an oil-based crosslinked gel.

8. The method of treating a subterranean formation from a well according to claim 1, wherein the second carrier fluid is an aqueous fluid which comprises no polar and/or oleophilic component.

9. The method of treating a subterranean formation from a well according to claim 1, wherein the second carrier fluid is a water-based crosslinked gel.

10. The method of treating a subterranean formation from a well according to claim 1, wherein the injecting the proppant slurry and the proppant free injection fluid comprises alternating injection of the proppant slurry and injection of the proppant free injection fluid through a single injection line into the wellhead.

11. The method of treating a subterranean formation from a well according to claim 1, wherein the injecting the proppant slurry and the proppant free injection fluid comprises injection of the proppant slurry through a first injection line into the wellhead and injection of the proppant free injection fluid through a second injection line into the wellhead, wherein the injections of the proppant slurry and proppant free injection fluid may be simultaneous or alternating.

12. The method of treating a subterranean formation from a well according to claim 8, wherein the injections of the proppant slurry and proppant free injection fluid are simultaneous.

13. The method of treating a subterranean formation from a well according to claim 1, further comprising forming heterogeneous proppant clusters in the subterranean formation.

14. The method of treating a subterranean formation from a well according to claim 1, wherein the first and/or second carrier fluids further comprise fibers.

15. The method of treating a subterranean formation from a well according to claim 1, wherein the proppant comprises one or more solid materials selected from the group consisting of sand, ceramic particles, sintered bauxites, glass beads, minerals, polymers, plastic particles, and any combination of two or more thereof.

16. The method of treating a subterranean formation from a well according to claim 14, wherein one or more of the solid materials have a plate like shape.

17. The method of treating a subterranean formation from a well according to claim 1, wherein the first carrier fluid and/or the second carrier fluid are in the form of a foam.
